(19) United States
(12) Patent Application Publication
(10) Pub. No.: US 2016/0330937 A1
(43) Pub. Date: Nov. 17, 2016

(54) Safety nail clipper for pets

(71) Applicant: Karina S. Peschardt, Rockville, MD (US)

(72) Inventor: Karina S. Peschardt, Rockville, MD (US)

(21) Appl. No.: 15/224,429

(22) Filed: Jul. 29, 2016

Related U.S. Application Data
(63) Continuation-in-part of application No. PCT/US2014/049835, filed on Aug. 5, 2014.
Application No. PCT/US2014/049835 is a continuation-in-part of application No. 14/171,547, filed on Feb. 3, 2014.
(60) Provisional application No. 61/760,255, filed on Feb. 4, 2013.

(51) Int. Cl. A01K 17/00; A01K 13/00

(52) U.S. Cl. CPC A01K 17/00; A01K 13/00

(57) ABSTRACT

A safety nail clipper for safe and fast cutting of the nails of a pet or wild animal can include a nail clipper body, a cutting implement, and a funnel, such that the funnel can guide a pet nail to a cutting location. Alternatively, a safety nail clipper can include a top piece, a top blade, a bottom piece, a bottom blade, and a funnel, such that the funnel guides a pet nail to a cutting location, where the top and the bottom blades meet when the top and bottom pieces are pressed together. Additionally, a safety nail clipper with a funnel can further include a safety stop, which serves to stop the nail from entering too far past the cutting location, to avoid cutting into the quick of the nail. Also disclosed are safety nail clippers for pets with lever handles, a center disc, or front and rear levers.

### CROSS-REFERENCE TO RELATED APPLICATIONS

This United States Non-Provisional Application is a continuation-in-part of International PCT application No. US2014/49835, filed Aug. 5, 2014, and a continuation-in-part of U.S. Non-Provisional application Ser. No. 14/171,547, filed Feb. 3, 2014, which claims the benefit of U.S. Provisional Application No. 61/760,255, filed Feb. 4, 2013.

### FIELD OF THE INVENTION

The present invention relates generally to the field of nail cutting devices for cats, dogs, and other pets.

### BACKGROUND OF THE INVENTION

Dogs and many other pets need to have their nails cut. However, most pets dislike having their nails cut. They will often become scared and agitated, and may struggle and wriggle, making it very tricky to use the traditional scissor and guillotine-style nail clippers. With one slight movement, the clippers can accidentally cut into the quick of the nail, causing pain, bleeding, and risking infection.

Consequently, most pet owners dread nail-cutting time. They face a difficult choice of either leaving it to professionals, such as vets and groomers, which is costly and time consuming, or doing it at home and saving the money and time, but risking hurting their pet.

There are nail clippers that are advertised as safe. Some, such as the original Millers Forge clippers and others like them, have a so-called safety bar. Its purpose is to aid in cutting the pet's nails at a safe length without getting too close to the quick.

Others are of the DREMEL® type. Here, the safety feature is a rotating file that shaves away the tip of the pet's nail. One such device on the market is the PETICURE®, another is the original DREMEL®.

Then there is the QUICKFINDER® range of nail clippers. The safety feature is a patented technology that senses the pet's quick and signals when it is safe to cut. Red light signals that the clipper is over the quick, yellow light that the clipper is near the quick, and green light that it is safe to cut.

But all types have limitations: The safety bar type necessitates the nail being led through to the very small area that is the safety bar. But a struggling and wriggling pet can make this difficult. Amid the furor, the nail easily ends up in the hollow area immediately next to the cutting hole. Here, incorrectly positioned, the nail will be cut in a skewed way that can cause injury. The fact that the nail clipper is advertised as safe increases this risk, because the owner operates in the mistaken belief that the clipper is foolproof safe, and so may cut too hastily and arbitrarily.

With the DREMEL® type, the risk of cutting the quick is eliminated, but injury can still ensue if the nail is filed too far. This battery-driven clipper is also quite expensive, and some pets do not react well to the vibration and noise. Yet their greatest problem is that they take a long time, as filing takes much longer than cutting. However, most dogs will not cooperate and stand still for the 10 minutes or more it takes to use the clipper.

With the QUICKFINDER® type, the instruction is to move the clipper slowly up the nail so the scanner can detect the change in the LED's. However, with the typical resisting pet, it is difficult to keep the paw steady for a sufficient amount of time. It is similarly problematic that the pet's nail has to be positioned precisely in the clipper. Another problem is that the sensor has to be “on”, meaning that the handles have to be kept partially squeezed while the nail is inserted. This, too, is awkward when trying to control a squirming pet.

Many users also report that the technology is ineffective; that the sensor detects the quick too quickly or too late. This merely gives a false sense of security. It is also often observed that the clipper does not cut cleanly through the nail, and may crush or split the nail. In addition, it may not be sturdy enough, causing the cutting blade to twist away from the portion of the blade that the nail fits through.

As such, considering the foregoing, it may be appreciated that there continues to be a need for novel and improved devices and methods for cutting the nails of a pet.

### SUMMARY OF THE INVENTION

The foregoing needs are met, to a great extent, by the present invention, wherein in aspects of this invention, enhancements are provided to the existing model of nail clippers for pets.

In aspects of this invention, a safety nail clipper for pets can include unique safety features, comprising:
a) a funnel, which helps guide the pet's nail to a cutting-style nail clipper, placed near the inside end of the funnel, or immediately adjacent to the end of the funnel, which is met by
b) a safety stop behind the cutting-style clipper. This safety stop ensures that it is not possible to cut off more of the pet's nail than the equivalent of the distance between the cutting-style clipper and the safety stop behind the cutting-style clipper.

In aspects of this invention, the safety nail clipper for pets uniquely solves the problems associated with current nail clipper devices because:
a) It is a cutting-style nail clipper, which means it is quick acting, but in contrast to the current cutting-style nail clippers, there is no area or hole in which the nail can mistakenly end up.
b) It includes a funnel, which ensures that the pet's nail is quickly and safely guided towards the cutter, so that there is nowhere else for it to go, and the nail is held still and steady at the desired place.
c) It includes a safety stop behind the cutter, to ensure that it is impossible to cut off more of the nail, than permitted by a safe distance between the cutter and the safety stop.
d) The cutting-style technology is lower-cost to manufacture and maintain, than Dremel and Quickfinder type clippers.
e) It emits no vibration or noise that can aggravate a pet.

These factors combine to make the safety nail clipper for pets a simultaneously quick, effective, convenient, cost-effective, no-vibration, no-noise, painless and uniquely safe solution for pet owners, groomers and vets to cut pets' nails.

Pet owners, and groomers and other professionals can benefit from using the safety nail clipper for pets to cut or trim their pets' nails or claws because they can rest assured that the safety nail clipper for pets will
a) help regulate the length and evenness of their pets' nails or claws;
b) operate quickly, effectively, conveniently, cost-effectively, without any vibration or noise, painlessly and safely.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a safety nail clipper for pets, according to an embodiment of the invention.

FIG. 2 is a side view of a safety nail clipper for pets, according to an embodiment of the invention.

FIG. 3 is a side view of a safety nail clipper for pets, illustrating a pet nail inside a funnel of the safety nail clipper for pets, according to an embodiment of the invention.

FIG. 4 is a bottom view of a safety nail clipper for pets, according to an alternative embodiment of the invention.

FIG. 5 is a top view of a traditional cutting-style nail clipper for pets.

FIG. 6 is a top view of a traditional cutting-style nail clipper for pets with an attached funnel, according to an embodiment of the invention.

FIG. 7 is a side view of a traditional cutting-style nail clipper for pets with an attached funnel and a safety stop, according to an embodiment of the invention.

FIG. 8 is a cross-sectional side view of a safety nail clipper for pets, illustrating a pet nail inside a funnel of the safety nail clipper for pets, according to an embodiment of the invention.

FIG. 9A is a cross-sectional side view of a safety nail clipper for pets, illustrating a pet nail inside a funnel of the safety nail clipper for pets, according to an embodiment of the invention.

FIG. 9B is a bottom view of a safety nail clipper for pets, according to an embodiment of the invention.

FIG. 10 is a cross-sectional side view of a safety nail clipper for pets with lever handles, according to an embodiment of the invention.

FIG. 11 is a perspective view of a safety nail clipper for pets with lever handles, according to an embodiment of the invention.

FIG. 12 is a cross-sectional side view of a safety nail clipper for pets with a center disc, according to an embodiment of the invention.

FIG. 13 is a perspective view of a safety nail clipper for pets with a center disc, according to an embodiment of the invention.

FIG. 14 is a cross-sectional side view of a safety nail clipper for pets with a diamond squeeze, according to an embodiment of the invention.

FIG. 15 is a perspective view of a safety nail clipper for pets with a diamond squeeze, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

Throughout this disclosure, a cutting-style nail clipper shall be understood to mean existing guillotine-style clippers, scissor- or plier-style clippers, opposing-blade clippers with a compound lever, and other type of clippers with a cutting implement that includes at least one blade, which is designed to cut the nails of a pet with a swift cutting action. A cutting implement can include a variety of designs, with one, two, or more cutting blades, such as for example including a multi-blade cutting implement, designed as the aperture mechanism of a camera.

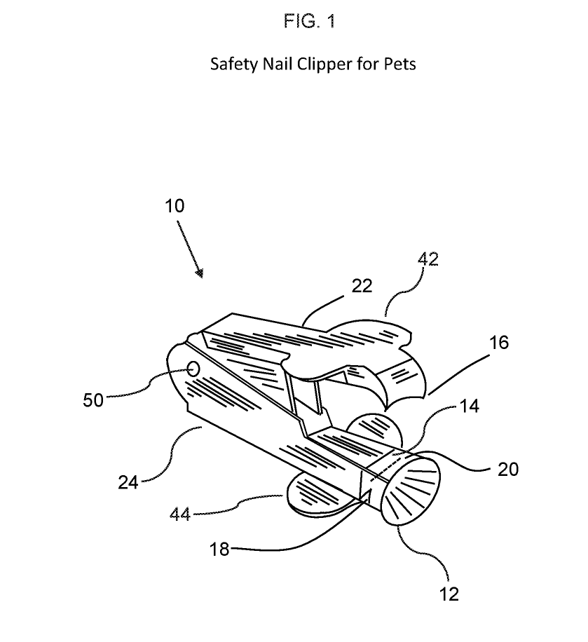

In the following, we describe the structure of an embodiment of a safety nail clipper for pets 10 with reference to FIG. 1, in such manner that like reference numerals refer to like components throughout; a convention that we shall employ for the remainder of this specification.

In an embodiment, a safety nail clipper for pets 10, can comprise:
a) A top piece 22,
b) A top blade 16, which is connected to, or a part of the front end of the top piece 22,
c) A bottom piece 24,
d) A bottom blade, 18 which is connected to, or a part of the front end of the bottom piece 24;
e) A funnel 12, which is positioned such that a front aperture of the funnel 12 is in front of the cutting location 20, which is the cutting line formed when the top piece 22 and the bottom piece 24 are pressed together, so that the top blade 16 and the bottom blade 18 are in contact, along a line constituting the cutting location 20; and
f) A safety stop 14, which is located behind the cutting location 20;
Whereby
(1) a pet nail 26 can be led into and through the funnel 12, such that the shape of the funnel 12 helps guide the pet nail 26 to the safety stop 14, that forms a wall preventing further entry, so that the tip 28 of the pet nail 26 comes to an automatic stop, simultaneously leaving the quick of the nail 30 at a natural stop 15 before reaching the cutting location 20, and subsequently;
(2) when the top blade 16 and bottom blade 18 are pressed together they meet at the cutting location 20, and in this process cut through the pet nail 26 between the tip of the pet nail 26 and the quick of the nail 30, leaving the quick of the nail 30 untouched and safe, such that the safety stop 14 ensures that it is not possible to cut off more of the pet's nail 26 than the equivalent of the distance between from where the top blade 16 and bottom blade 18 come together at the cutting location 20 to the safety stop 14, which acts as a wall preventing further entry, behind the cutting-style clipping action.

In related embodiments, the top piece 22, and the top blade 16 can be of identical shape, construction and size as the bottom piece 24, and the bottom blade 18, whereby the safety nail clipper 10 is top-bottom symmetrical, or substantially symmetrical, so that the top piece 22, and the top blade 16, can be referred to as respectively the first piece, and the first blade, and the bottom piece 24, and the bottom blade 18, can be referred to as the second piece, and the second blade. Correspondingly, any components referred to as a top or a bottom component can alternatively be referred to as respectively a first or second component. Any reference to a top and/or a bottom component, shall not be construed to imply top-bottom asymmetry, but shall include in its scope both asymmetric and top-bottom symmetric embodiments.

In related embodiments, the combination of the safety stop 14 and the position of the cutting location 20 means that it is impossible to cut off more of a pet's nail 26 than the equivalent of the distance between the safety stop 14 and the position of the cutting location 20. This very significantly reduces or eliminates the risk of cutting off too much of a nail, thereby cutting into the quick of the nail, causing pain, bleeding and possible infection.

In a related embodiment, the top piece 22 and the bottom piece 24 can be pivotally connected via a connection point 50, which can be a connection pin, or some other common fastening mechanism allowing pivotal rotation of the top piece 22 relative to the bottom piece 24, such that the connection point 50 forms a rotation center. The connection pin can be located in the back ends of the top piece 22 and the bottom piece 24, opposite to the respective locations of the top blade 16 and the bottom blade 18.

In related embodiments, the combination of the funnel 12 and the cutting-style clipper as constituted by the top blade 16 and bottom blade 18 coming together, also means that the safety nail clipper for pets 10 can be uniquely quick acting. The funnel 12 allows for a pet's nail 26 to be quickly and seamlessly guided to the quick-acting cutting-style clipping action, which significantly reduces the stress caused to the pet, and which makes the safety nail clipper for pets 10 far easier and more efficient to use on the pet.

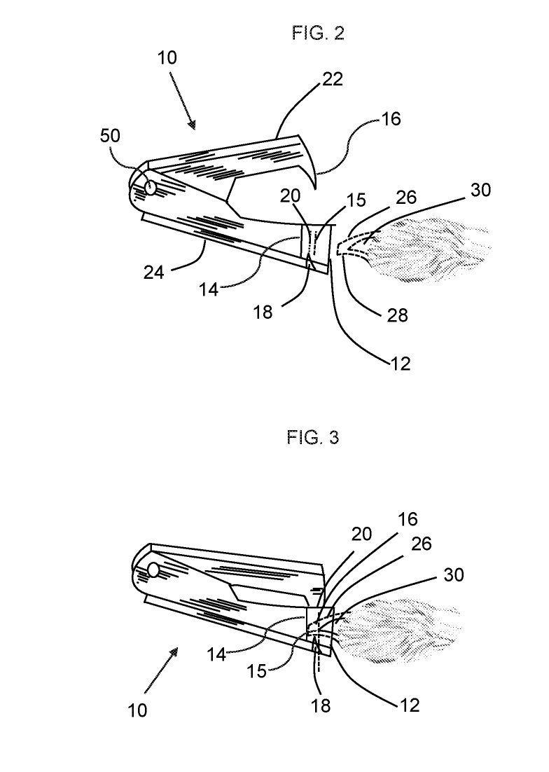

In a related embodiment, FIG. 2 illustrates a side view of the safety nail clipper for pets 10 showing the funnel 12, the wall that constitutes the safety stop 14, the top blade 16 and the bottom blade 18 that come together at the cutting location 20 just behind, and adjacent to or in close proximity to the funnel 12 when the top piece 22 and the bottom piece 24 are pressed together. The pet nail 26 with tip 28 and quick 30 is shown at the entrance of the funnel 12, ready to be led into and through the funnel 12 and towards the safety stop 14.

In a related embodiment, FIG. 3 illustrates a side view of the safety nail clipper for pets 10 where the pet nail 26 has been led into and through the funnel 12, the shape of which has helped guide the pet nail 26 to the wall that constitutes the safety stop 14 where the tip of the pet nail 28 has come to an automatic stop, simultaneously leaving the quick of the nail 30 at a natural stop 15 in front of the cutting location 20. The top blade 16 and bottom blade 18 have been pressed together so they meet at the cutting location 20 just behind, and adjacent to or in close proximity to the funnel 12, and in this process have cut through the pet nail 26 between the tip of the pet nail 28 and the quick of the nail 30, leaving the quick of the nail 30 untouched and safe.

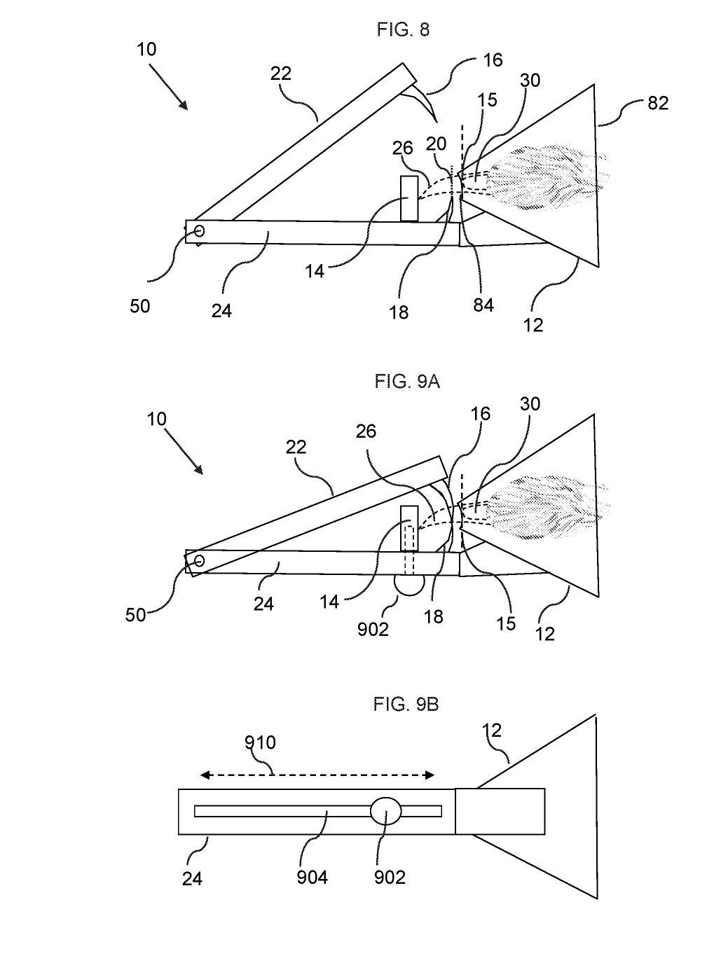

In a related embodiment, FIG. 8 illustrates a cross-sectional side-view, of a safety nail clipper for pets 10, showing the top and bottom pieces 22 24 in an open position, the top and bottom blades 16 18, the connection point 50, the safety stop 14, the funnel 12, with a nail 26, showing the inside quick 30, such that the nail 26 is inserted through the funnel 12, and has reached the safety stop 14, whereby it is in a position ready to be cut;

whereby
1. a pet nail 26 can be led into and through the funnel 12, such that the shape of the funnel 12 helps guide the pet nail 26 to the safety stop 14, that forms a wall preventing further entry, so that the tip 28 of the pet nail 26 comes to an automatic stop, simultaneously leaving the quick of the nail 30 at a natural stop 15 before reaching the cutting location 20, and subsequently;
2. when the top blade 16 and bottom blade 18 are pressed together they meet at the cutting location 20, and in this process cut through the pet nail 26 between the tip of the pet nail 26 and the quick of the nail 30, leaving the quick of the nail 30 untouched and safe, such that the safety stop 14 ensures that it is not possible to cut off more of the pet's nail 26 than the equivalent of the distance between from where the top blade 16 and bottom blade 18 come together at the cutting location 20 to the safety stop 14, which acts as a wall preventing further entry, behind the cutting-style clipping action.

FIG. 8 illustrates an embodiment, wherein the funnel 12 is mounted entirely in front of the cutting location 20, such that a rear aperture 84 of the funnel 20 is in front of and in close proximity to the cutting location 20. Normally a close proximity distance between the rear funnel aperture 84 and the cutting location 20 can be predetermined within a range from 1 mm to 25 mm, but this can vary according to the particular application.

Furthermore, FIG. 8 illustrates an embodiment wherein the front funnel aperture 82 is wider than the rear funnel aperture 84, in order to guide the nail of a pet to the cutting location.

FIG. 9A illustrates the embodiment shown in FIG. 8, in a state where the top and bottom pieces 22 24 are in a closed position, and the nail 26 has been cut, without injury to the quick 30.

In related embodiments, the safety nail cutter for pets 10 can be manufactured from materials well known by persons of ordinary skill in the art to be suitable for standard nail-cutters, such as stainless steel, aluminum, and various types of plastic. The top and bottom blades 16 18, can be made from various hardened and sharpened materials including alloys of stainless steel, and suitable ceramic materials.

In related embodiments, the distance between the safety stop 14 and the cutting location 20 can be predetermined such that the safety nail clipper for pets 10 is designed for pets of a particular species and size. Normally the distance between the safety stop 14 and the cutting location 20 can be predetermined within a range from 1 mm to 25 mm, but this can vary according to the particular application.

In a further related embodiment, the position of the safety stop 14 can be adjusted, whereby the distance between the safety stop 14 and the cutting location 20 can be adjustable, allowing for use with different sizes and types of pet nails, such as for example shown in FIGS. 9A and 9B, wherein the safety stop is releasably secured in position by a screw 902, such that the screw 902 screws into the safety stop 14 through a slit in the bottom piece 24, such that the screw 902 and safety stop 14 can slide along 910 the slit 904, when the screw is untightened, such that the safety stop is secured in position when the screw 902 is tightened. The screw can be configured to be tightened using fingers or a tool, such as a wrench.

In related embodiments, the funnel 12 can be made with an alternative shape such as oval, elliptical, rectangular or triangular, or other shapes.

In a related embodiment, the funnel 12 can have a shape that does not gradually narrow.

In a related embodiment, the funnel 12 can be detachable from and re-attachable to the main body or basic frame of the safety nail clipper for pets 10, allowing different sizes and/or lengths of funnels 12 to accommodate different types of pets such as dogs, cats, rabbits, etc. and their different sizes and lengths of nails and claws.

In related embodiments, the funnel 12, can be
a) mounted entirely in front of the cutting location 20,
b) Or, alternatively, mounted so that a part of the funnel 12 continues after the cutting location 20 until reaching the safety stop 14, in which case the funnel may have top and/or bottom apertures to allow respectively the top and bottom cutting blades 16 18 to reach the cutting location 20. Optionally, one of the cutting blades 16 18 can be mounted inside the funnel 12.

In a related embodiment, the funnel 12 can be made of a transparent material, such as a transparent plastic, whereby the funnel 12 can allow for see-through operation.

In related embodiments, the top blade 16 and/or the bottom blade 18 can be manufactured with a plurality of alternative matching curvatures or shapes, including a straight design of both the top blade 16 and the bottom blade 18.

In a related embodiment, the safety nail clipper 10 can further comprise a wing-style top grip 42 and a similar wing-style bottom grip 44, whereby a user can press on the grips, for example with a thumb on the top grip 42 and a corresponding hand index finger on the bottom grip 44.

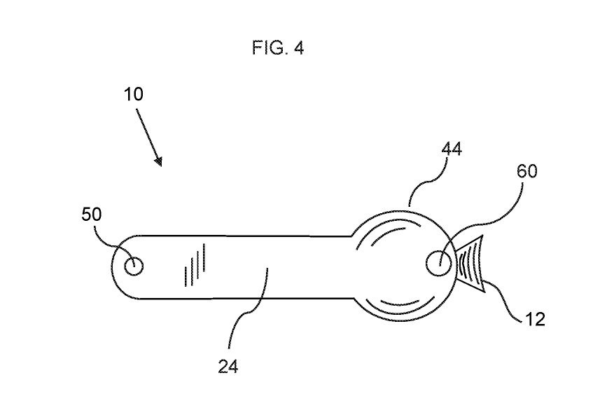

In related embodiments, the top piece 22 and/or bottom piece 24 can be made with a plurality of alternative shapes. In a further related example embodiment, FIG. 4 illustrates a bottom view of one such alternative shape, wherein the wing-style top and bottom grips 42 44 on the top piece 22 and bottom piece 24 of the safety nail clipper for pets 10 is replaced by circular style grips.

In a related embodiment, illustrated in FIG. 4, the safety nail clipper 10 can have an ejection hole 60, or opening, in a location between the cutting location 20 and the safety stop 14 that accommodates gravity induced falling out and emptying of nail cuttings. In various further related embodiments, depending on configuration, the ejection hole 60 can be in the bottom piece 24, in the funnel 12, or in another part of the safety nail clipper 10.

In a further related embodiment, a container or box can be placed below the ejection hole 60, to collect nail cuttings. The container can be configured in a position inside the safety nail clipper 10, or can be externally mounted.

In related embodiments, the safety nail clipper for pets 10 can be used on the nails or claws of wild animals.

In a related embodiment, the safety nail clipper for pets 10 can be used to trim the beaks of birds.

In a related embodiment, the funnel 12 itself and the principles underlying the functionality and benefit of the funnel 12, i.e. the quick and seamless guiding of the pet's nail 26 towards the cutting action and the steady positioning of it at the safety stop 14 and cutting location 20, can be applied to and work in conjunction with any other existing types and styles of nail clippers and nail trimmers. In this relation, such existing types of nail clippers and nail trimmers, can be characterized as comprised of:
a) a cutting implement, which is designed to cut the nail, and can be designed as a scissor- or plier-style, guillotine-style, or other common cutting mechanism used for nail clippers and nail trimmers. The cutting implement can be manually operated or operated by an in-built electric motor; and
b) a main body, to which the cutting implement is attached. The main body can be further comprised of scissor handles, or other components to hold and operate the existing nail clipper or trimmer.

In a further related embodiment, a safety nail clipper 10 can comprise a funnel 12, a safety stop 14, and a cutting implement, with a main body that includes a compound lever, which serves to gain a mechanical advantage in operation of the cutting implement, similar to compound levers used in existing nail clippers.

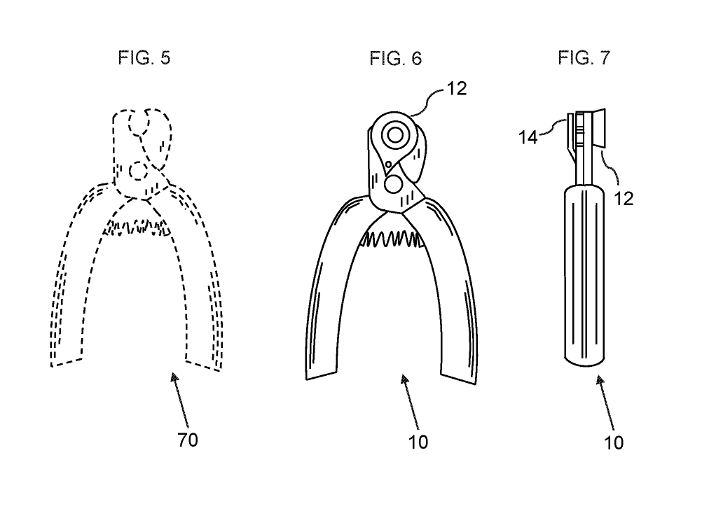

In another further related embodiment, FIG. 5, FIG. 6, and FIG. 7 are views of one such alternative application of the funnel principle; FIG. 5 illustrates a top view of a traditional cutting-style clipper 70, further comprised of a cutting implement. FIG. 6 shows a top view of an embodiment of the safety nail clipper for pets 10, with the entrance of the funnel 12 attached to and working in conjunction with the traditional cutting-style clipper 70. FIG. 7 illustrates a side view of a related embodiment of the safety nail clipper for pets 10, with the funnel 12 that is attached to and working in conjunction with the traditional cutting-style clipper 70, and a safety stop 14.

In an embodiment, the funnel 12 can have cutouts, such as cutouts in both sides, to provide space for digits of a pet, adjacent to the nail currently being cut.

In a related embodiment, the funnel 12 can consist solely of a base, functioning as a resting platform, upon which the animal's digit can be guided to the cutting blades 16 18 and rest while being cut. The base can further include slightly upward-turned side semi-walls. The base can hereby be viewed as a funnel without a roof, or a funnel without sides and roof, or a combination of these variants.

In an embodiment, a front facing surface of the safety stop 14 can be rough, such as similar to the surface of a nail file, such that it can be used as a nail file to smoothen the tip of a nail after cutting.

In a related embodiment, the constituents of the safety nail clipper for pets 10 can take an alternative shape, format or form.

In a related embodiment, different materials, sizes and interconnections can be used for all components.

In various related embodiments, such as shown in FIGS. 5-7, a safety attachment device 12 can be configured to be attached to a conventional nail clipper 70, thereby forming a safety nail clipper for pets 10. The safety attachment device, can include a funnel 12 and can be designed to be removably attachable to a plurality of conventional nail clippers 70. Such a safety attachment device 12 can for example be sold separately in order for consumers to attach the safety attachment device 12 to their existing conventional nail clippers 70.

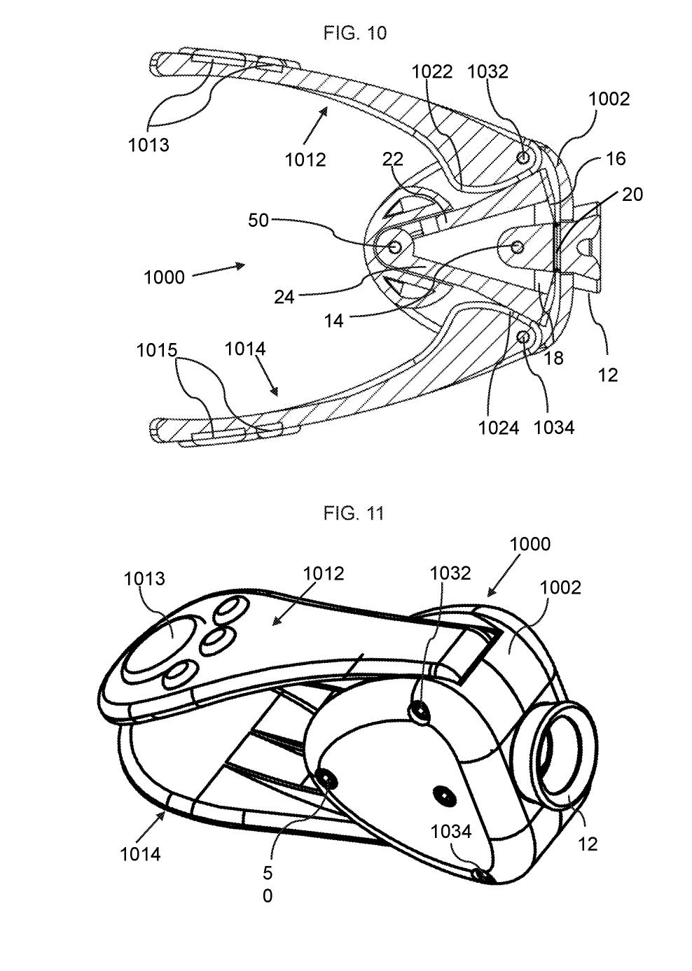

In an example embodiment, FIG. 10 shows a cross-sectional view of a safety nail clipper for pets with lever handles 1000, including:
a) An outer body 1002;
b) A top lever handle 1012, further including a top soft handle grip 1013 and a top lever protrusion 1032, such that the top lever handle 1012 is pivotally connected to the outer body 1002, in a top pivotal point 1032;
c) A bottom lever handle 1014, further including a bottom soft handle grip 1015 and a bottom lever protrusion 1034; such that the bottom lever handle 1014 is pivotally connected to the outer body 1002, in a bottom pivotal point 1034;
d) A top piece 22;
e) A top blade 16, which is connected to, or a part of the front end of the top piece 22;
f) A bottom piece 24; such that the top piece 22 and the bottom piece 24 are pivotally connected via a connection point 50, in the back ends of respectively the top and bottom pieces 22 24;
g) A bottom blade, 18 which is connected to, or a part of the front end of the bottom piece 24;
h) A funnel 12, which is positioned such that a front aperture of the funnel 12 is in front of the cutting location 20, which is the cutting line formed when the top piece 22 and the bottom piece 24 are pressed together, so that the top blade 16 and the bottom blade 18 are in contact, along a line constituting the cutting location 20; and
i) A safety stop 14, which is located behind the cutting location 20;
Such that the top and bottom lever handles 1012 1014 are mounted respectively above and under the top and bottom pieces 22 24, with the top and bottom lever protrusions 1022 1024 positioned behind respectively the top and bottom pivotal points 1032 1034, resting against respective outer surfaces of the top and bottom pieces 22 24, such that when an outside pressure is applied to respectively the top and bottom lever handles 1012 1014, thereby pressing the handles 1012 1014 together, a leveraged force is applied by the first and second lever protrusions 1022 1024 to the outer surfaces of the top and bottom pieces 22 24, thereby pressing the top and bottom pieces together, and thereby causing the top and bottom blades 16 18 to be pressed together.

In a related embodiment, FIG. 11 shows a perspective view of the safety nail clipper for pets with lever handles 1000 in a closed configuration, with the lever handles 1012 1014 pressed together. The lever handles 1012 1014 provide additional leverage, which significantly increases the cutting force.

In a related embodiment, the connection point 50 can include a torsion spring mechanism, to keep the safety nail clipper 1000 in an open position when no pressure is applied to the lever handles 1012 1014. Alternatively a spring can be mounted between the upper and lower pieces 22 24.

In various related embodiments, the blades 16 18 can be replaceable.

In various related embodiments, the funnel 12 can be built in to the outer body 1002 or can be a separate component.

In various related embodiments, the funnel 12 can protrude from the outer body 1002 or can be flush with a front surface of the outer body 1002.

In various related embodiments, the angle of handles or pieces can be offset at different angles from the angle of the blades, and the associated direction of the cutting location. For example, FIGS. 6 and 10 illustrate embodiments, where an angle is configured to cut a nail respectively to a side of the direction of the handles, or in front of the direction of the handles, when the handles are pressed together for cutting.

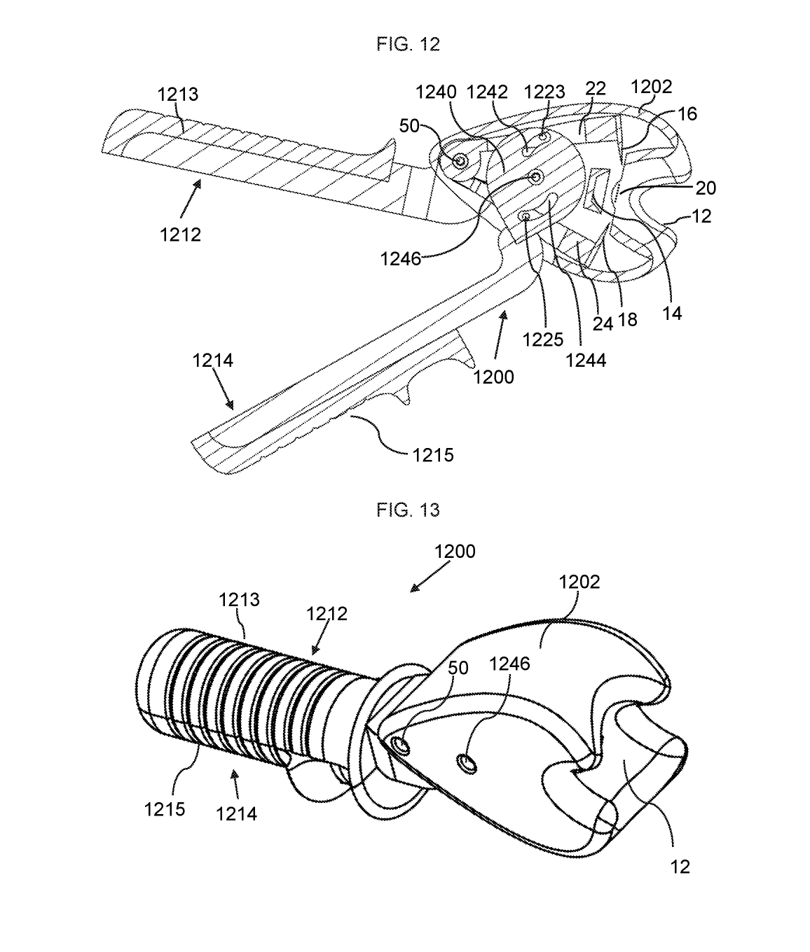

In another example embodiment, FIG. 12 shows a cross-sectional view of a safety nail clipper for pets with a center disc 1200, including:
a) An outer body 1202;
b) A top lever handle 1212, further including a top soft handle grip 1213, such that a front end of the top lever handle 1212 is connected to the outer body 1202;
c) A disc 1240, with a centrally positioned disc center 1246, which is pivotally connected to the outer body 1202, the disc 1240 further comprising: a top elongated slot 1242 and a bottom elongated slot 1244, such that the slots 1242 1244 are positioned on opposite sides of the disc center 1246;
d) A bottom lever handle 1214, further including a bottom soft handle grip 1215; such that a front end of the bottom lever handle 1214 is connected to the disc 1240;
e) A top piece 22, further comprising a top disc pin 1223;
f) A top blade 16, which is connected to, or a part of the front end of the top piece 22;
g) A bottom piece 24, further comprising a bottom disc pin 1225, such that the top piece 22 and the bottom piece 24 are pivotally connected via a connection point 50, in the back ends of respectively the top and bottom pieces 22 24;
h) A bottom blade, 18 which is connected to, or a part of the front end of the bottom piece 24;
i) A funnel 12, which is positioned such that a front aperture of the funnel 12 is in front of the cutting location 20, which is the cutting line formed when the top piece 22 and the bottom piece 24 are pressed together, so that the top blade 16 and the bottom blade 18 are in contact, along a line constituting the cutting location 20; and
j) A safety stop 14, which is located behind the cutting location 20;
wherein the disc 1240 can be mounted adjacent to both the top and bottom pieces 22 24, such that the top disc pin 1223 is secured in place inside the top elongated slot 1242, and the bottom disc pin 1225 is secured in place inside the bottom elongated slot 1244, such that when an outside pressure is applied to respectively the top and bottom lever handle 1212 1214, thereby pressing the handles 1212 1214 together, a leveraged force is applied by the second lever handle to rotate the disc 1240, such that the top and bottom pins slide inside the slots 1242 1244 until reaching respective ends of the slots 1242 1244, such that further rotation of the disc 1240 causes a leveraged force to be applied via the pins 1223 1225 to the top and bottom pieces 22 24, thereby pressing the top and bottom pieces 22 24 together, and thereby causing the top and bottom blades 16 18 to be pressed together.

In a related embodiment, FIG. 13 shows a perspective view of the safety nail clipper for pets with a center disc 1200 in a closed configuration, with the top and bottom lever handles 1212 1214 pressed together.

The embodiment illustrated in FIGS. 12 and 13, shows an example of a funnel 12 with cutouts in the top and bottom and the sides of the funnel, whereby additional space is provided for the digits of a paw of a pet to enter the funnel 12.

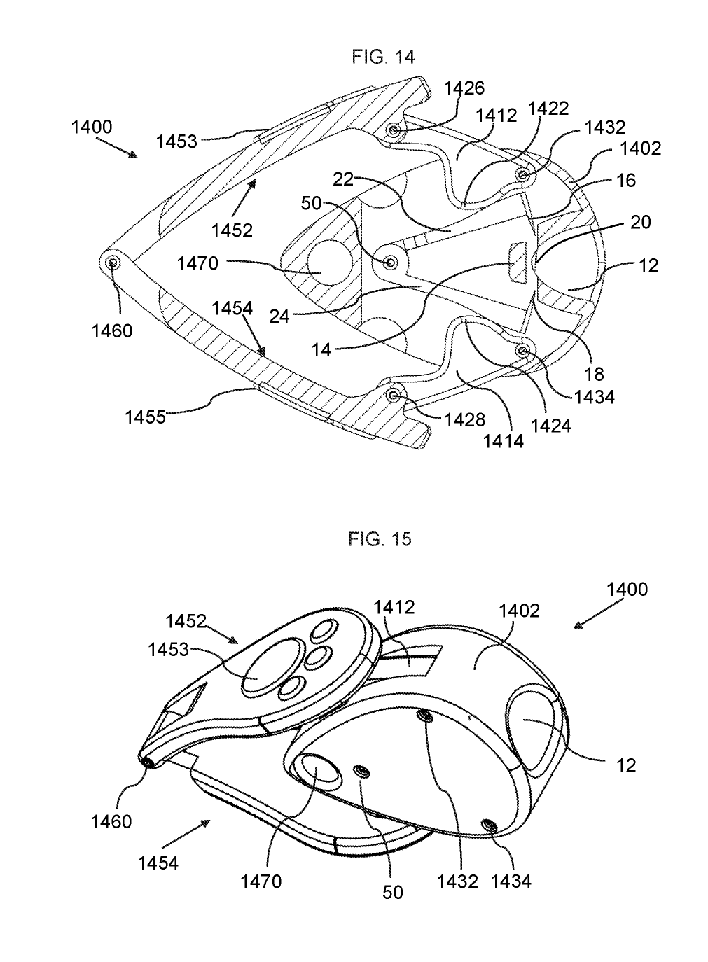

In yet another example embodiment, FIG. 14 shows a cross-sectional view of a safety nail clipper for pets with a diamond squeeze 1400, including:
a) An outer body 1402;
b) A top front lever 1412, further including a top lever protrusion 1422, such that the top lever handle 1412 is pivotally connected in a front end of the top lever handle 1412 to the outer body 1402, in a front top pivotal point 1432;
c) A bottom front lever 1414, further including a second lever protrusion 1424, such that the bottom front lever 1414 is pivotally connected to the outer body 1402, in a bottom front pivotal point 1434;
d) A top rear handle lever 1452, which can further include a top soft handle grip 1453, such that a front end of the top rear handle lever 1452 is pivotally connected to a rear end of the top front lever 1412, in a rear top pivotal point 1426;
e) A bottom rear handle lever 1454, which can further include a bottom soft handle grip 1455, such that a front end of the bottom rear handle lever 1454 is pivotally connected to a rear end of the bottom front lever 1414, in a rear bottom pivotal point 1428, and a rear end of the top rear handle lever 1452 is pivotally connected to a rear end of the bottom rear handle lever 1454, in a rear end pivotal point 1460;
f) A top piece 22;
g) A top blade 16, which is connected to, or a part of the front end of the top piece 22;
h) A bottom piece 24; such that the top piece 22 and the bottom piece 24 are pivotally connected via a connection point 50, in the back ends of respectively the top and bottom pieces 22 24;
i) A bottom blade, 18 which is connected to, or a part of the front end of the bottom piece 24;
j) A funnel 12, which is positioned such that a front aperture of the funnel 12 is in front of the cutting location 20, which is the cutting line formed when the top piece 22 and the bottom piece 24 are pressed together, so that the top blade 16 and the bottom blade 18 are in contact, along a line constituting the cutting location 20; and
k) A safety stop 14, which is located behind the cutting location 20;
Such that the top and bottom lever handles 1412 1414 are mounted respectively above and under the top and bottom pieces 22 24, with the top and bottom lever protrusions 1422 1424 positioned behind the pivotal points 1432 1434, resting against respective outer surfaces of the top and bottom pieces 22 24, such that when an outside pressure is applied to respectively the top and bottom rear lever handles 1452 1454, thereby pressing the top and bottom rear lever handles 1452 1454 together, such that top and bottom front levers 1412 1414 are pressed together via the rear top and bottom pivotal points 1426 1428, such that a leveraged force is applied by the first and second lever protrusions 1422 1424 to the outer surfaces of the first and second pieces 22 24, thereby pressing the top and bottom pieces together, and thereby causing the top and bottom blades 16 18 to be pressed together.

In a related embodiment, a central hole 1470 can be used with an index or middle finger to give a user more control.

In a related embodiment, FIG. 15 shows a perspective view of the safety nail clipper for pets with a diamond squeeze 1400 in a closed configuration, with the top and bottom rear handle levers 1452 1454 pressed together.

Various embodiments can thus include:

Embodiment 1: A safety nail clipper for safe and fast cutting of a nail of a pet or wild animal, comprising:
a) a top piece;
b) a top blade, which is connected to a front end of the top piece;
c) a bottom piece, wherein the top piece is connected to the bottom piece;
d) a bottom blade, which is connected to a front end of the bottom piece;
e) a funnel, which is positioned such that a front aperture of the funnel is in front of a cutting location, wherein the cutting location is formed when the top piece and the bottom piece are pressed together, such that the top blade and the bottom blade are in contact, along a line constituting the cutting location;
whereby the funnel guides the nail into and through the funnel, such that a shape of the funnel guides the nail to the cutting location, whereby further when the top blade and the bottom blade are pressed together they meet at the cutting location, and thereby cut through the nail, between the tip of the nail, and the quick of the nail, leaving the quick of the nail untouched and safe.

Embodiment 2: The safety nail clipper of embodiment 1, further comprising:
f) a safety stop, which is positioned behind the cutting location;
whereby the funnel guides a pet nail into and through the funnel, such that the shape of the funnel guides the pet nail to the safety stop, that forms a wall preventing further entry, such that a tip of the pet nail comes to an automatic stop, simultaneously leaving a quick of the nail at a natural stop before reaching the cutting location; and
whereby further when the top blade and the bottom blade are pressed together they meet at the cutting location, and thereby cut through the pet nail between the tip of the pet nail and the quick of the nail, leaving the quick of the nail untouched and safe, such that the safety stop ensures that it is not possible to cut off more of the pet's nail than the equivalent of a distance between from where the top blade and the bottom blade come together, at the cutting location, to the safety stop.

Embodiment 3: The safety nail clipper of embodiment 1, wherein the top piece and the bottom piece are pivotally attached at a connection point, which forms a rotation center.

Embodiment 4: The safety nail clipper of embodiment 2, wherein a position of the safety stop is adjustable, whereby a distance between the safety stop and the cutting location is adjustable, thereby allowing for use with different sizes and types of pet nails.

Embodiment 5: The safety nail clipper of embodiment 1, wherein the funnel is entirely in front of the cutting location, such that a rear aperture of the funnel is in front of and in close proximity to the cutting location.

Embodiment 6: The safety nail clipper of embodiment 1, wherein the funnel is configured with a narrowing shape, such that the front funnel aperture is wider than a rear funnel aperture.

Embodiment 7: The safety nail clipper of embodiment 1, wherein the funnel is a straight cylinder.

Embodiment 8: The safety nail clipper of embodiment 1, wherein the funnel is made of a transparent material.

Embodiment 9: The safety nail clipper of embodiment 2, further comprising an ejection hole located between the cutting location and the safety stop, whereby the ejection hole accommodates gravity induced falling out and emptying of nail cuttings.

Embodiment 10: The safety nail clipper of embodiment 1, wherein the top piece further comprises a top grip, and the bottom piece further comprises a bottom grip.

Embodiment 11: The safety nail clipper of embodiment 1, wherein the funnel further comprises at least one cutout.

Embodiment 12: The safety nail clipper of embodiment 1, wherein the funnel is comprised solely of a base, whereby the base functions as a resting platform.

Embodiment 13: The safety nail clipper of embodiment 2, wherein a front facing surface of the safety stop is rough, whereby it functions to smoothen the tip of the nail after cutting.

Embodiment 14: The safety nail clipper of embodiment 1, wherein the top and bottom blades are replaceable.

Embodiment 15: The safety nail clipper of embodiment 1, further comprising:
a) an outer body;
b) a top lever handle, further comprising a top lever protrusion, such that the top lever handle is pivotally connected to the outer body, in a top pivotal point;
c) a bottom lever handle, further comprising a bottom lever protrusion; such that the bottom lever handle is pivotally connected to the outer body, in a bottom pivotal point;
such that the top and bottom lever handles are mounted respectively above and under the top and bottom pieces, with the top and bottom lever protrusions positioned behind respectively the top and bottom pivotal points, resting against respective outer surfaces of the top and bottom pieces, such that when an outside pressure is applied to respectively the top and bottom lever handles, thereby pressing the top and bottom lever handles together, a leveraged force is applied by the top and bottom lever protrusions to the outer surfaces of the top and bottom pieces, thereby pressing the top and bottom pieces together, and thereby causing the top and bottom blades to be pressed together.

Embodiment 16: The safety nail clipper of embodiment 1, further comprising:
a) an outer body;
b) a top lever handle, further comprising a top lever protrusion, such that the top lever handle is connected to the outer body;
c) a disc, with a centrally positioned disc center, which is pivotally connected to the outer body, the disc further comprising: a top elongated slot and a bottom elongated slot, such that the top and bottom elongated slots are positioned on opposite sides of the disc center;
d) a bottom lever handle, further comprising a bottom soft handle grip, such that the bottom lever handle is connected to the disc;
wherein the top piece further comprises a top disc pin; the bottom piece further comprises a bottom disc pin, such that the top piece and the bottom piece are pivotally connected in the back ends of respectively the top and bottom pieces, via a connection point; and
wherein the disc is mounted adjacent to the top and bottom pieces, such that the top disc pin is secured in place inside the top elongated slot, and the bottom disc pin is secured in place inside the bottom elongated slot, such that when an outside pressure is applied to respectively the top and bottom lever handle, thereby pressing the handles together, a leveraged force is applied by the bottom lever handle to rotate the disc, such that the top and bottom pins slide inside the slots until reaching respective ends of the slots, such that further rotation of the disc causes a leveraged force to be applied via the top and bottom disc pins to the top and bottom pieces, thereby pressing the top and bottom pieces together, and thereby causing the top and bottom blades to be pressed together.

Embodiment 17: The safety nail clipper of embodiment 1, further comprising:
a) an outer body;
b) a top front lever, further including a top lever protrusion, such that the top lever handle is pivotally connected in a front end of the top lever handle to the outer body, in a front top pivotal point;
c) a bottom front lever, further including a bottom lever protrusion, such that the bottom front lever is pivotally connected to the outer body, in a bottom front pivotal point;
d) a top rear handle lever, wherein a front end of the top rear handle lever is pivotally connected to a rear end of the top front lever, in a rear top pivotal point;
e) a bottom rear handle lever, such that a front end of the bottom rear handle lever is pivotally connected to a rear end of the bottom front lever, in a rear bottom pivotal point, and a rear end of the top rear handle lever is pivotally connected to a rear end of the bottom rear handle lever, in a rear end pivotal point;
such that the top and bottom lever handles are mounted respectively above and under the top and bottom pieces, with the top and bottom lever protrusions positioned such that they are resting against respective outer surfaces of the top and bottom pieces, such that when an outside pressure is applied to respectively the top and bottom rear lever handles, thereby pressing the top and bottom rear lever handles together, such that top and bottom front levers are pressed together via the rear top and bottom pivotal points, such that a leveraged force is applied by the top and bottom lever protrusions to the outer surfaces of the top and bottom pieces, thereby pressing the top and bottom pieces together, and thereby causing the top and bottom blades to be pressed together.

Embodiment 18: A safety nail clipper for safe and fast cutting of a nail of a pet or wild animal, comprising:
a) a nail clipper body;
b) a cutting implement, wherein the cutting implement is connected to the nail clipper body, and is configured to cut the nail at a pre-determined cutting location in the front of the nail clipper body, wherein further the nail is cut as a result of a cutting motion of the cutting implement;
c) a funnel, which is positioned such that a front aperture of the funnel is in front of the cutting location;
whereby the funnel guides the nail into and through the funnel, such that the shape of the funnel is configured to guide the nail to the cutting location, whereby further during cutting motion of the cutting implement, the nail is cut between a tip of the nail and a quick of the nail, leaving the quick of the nail untouched and safe.

Embodiment 19: The safety nail clipper of embodiment 18, further comprising:
d) a safety stop, which is positioned behind the cutting location;
whereby the funnel guides the nail into and through the funnel, such that the shape of the funnel guides the nail to the safety stop, that forms a wall preventing further entry, such that a tip of the nail comes to an automatic stop, simultaneously leaving a quick of the nail at a natural stop before reaching the cutting location; and
whereby further when the top blade and the bottom blade are pressed together they meet at the cutting location, and thereby cut through the pet nail between the tip of the pet nail and the quick of the nail, leaving the quick of the nail untouched and safe, such that the safety stop ensures that it is not possible to cut off more of the nail than the equivalent of the distance between from where the top blade and the bottom blade come together, at the cutting location, to the safety stop, which acts as a wall preventing further entry.

Embodiment 20: The safety nail clipper of embodiment 18, wherein the cutting implement further comprises a top piece connected with a top blade, and a bottom piece connected with a bottom blade, wherein the top piece and the bottom piece are pivotally attached at a connection point, which forms a rotation center.

Embodiment 21: The safety nail clipper of embodiment 19, wherein a position of the safety stop is adjustable, whereby a distance between the safety stop and the cutting location is adjustable, thereby allowing for use with different sizes and types of nails.

Embodiment 22: The safety nail clipper of embodiment 18, wherein the funnel is entirely in front of the cutting location, such that a rear aperture of the funnel is in front of and in close proximity to the cutting location.

Embodiment 23: The safety nail clipper of embodiment 18, wherein the funnel is configured with a narrowing shape, such that a front funnel aperture is wider than a rear funnel aperture.

Embodiment 24: The safety nail clipper of embodiment 18, wherein the funnel is a straight cylinder.

Embodiment 25: The safety nail clipper of embodiment 18, wherein the funnel is made of a transparent material.

Embodiment 26: The safety nail clipper of embodiment 19, further comprising an ejection hole located between the cutting location and the safety stop, whereby the ejection hole accommodates gravity induced falling out and emptying of nail cuttings.

Embodiment 27: The safety nail clipper of embodiment 20, wherein the top piece further comprises a top grip and the bottom piece further comprises a bottom grip.

Embodiment 28: The safety nail clipper of embodiment 20, further comprising:
a) an outer body;
b) a top lever handle, further comprising a top lever protrusion, such that the top lever handle is pivotally connected to the outer body, in a top pivotal point;
c) a bottom lever handle, further comprising a bottom lever protrusion; such that the bottom lever handle is pivotally connected to the outer body, in a bottom pivotal point;
such that the top and bottom lever handles are mounted respectively above and under the top and bottom pieces, with the top and bottom lever protrusions positioned behind respectively the top and bottom pivotal points, resting against respective outer surfaces of the top and bottom pieces, such that when an outside pressure is applied to respectively the top and bottom lever handles, thereby pressing the top and bottom lever handles together, a leveraged force is applied by the top and bottom lever protrusions to the outer surfaces of the top and bottom pieces, thereby pressing the top and bottom pieces together, and thereby causing the top and bottom blades to be pressed together.

Embodiment 29: The safety nail clipper of embodiment 20, further comprising:
a) an outer body;
b) a top lever handle, further comprising a top lever protrusion, such that the top lever handle is connected to the outer body;
c) a disc, with a centrally positioned disc center, which is pivotally connected to the outer body, the disc further comprising: a top elongated slot and a bottom elongated slot, such that the top and bottom elongated slots are positioned on opposite sides of the disc center;
d) a bottom lever handle, further comprising a bottom soft handle grip, such that the bottom lever handle is connected to the disc;
wherein the top piece further comprises a top disc pin; the bottom piece further comprises a bottom disc pin, such that the top piece and the bottom piece are pivotally connected in the back ends of respectively the top and bottom pieces, via a connection point; and
wherein the disc is mounted adjacent to the top and bottom pieces, such that the top disc pin is secured in place inside the top elongated slot, and the bottom disc pin is secured in place inside the bottom elongated slot, such that when an outside pressure is applied to respectively the top and bottom lever handle, thereby pressing the handles together, a leveraged force is applied by the bottom lever handle to rotate the disc, such that the top and bottom pins slide inside the slots until reaching respective ends of the slots, such that further rotation of the disc causes a leveraged force to be applied via the top and bottom disc pins to the top and bottom pieces, thereby pressing the top and bottom pieces together, and thereby causing the top and bottom blades to be pressed together.

Embodiment 30: The safety nail clipper of embodiment 20, further comprising:
a) an outer body;
b) a top front lever, further including a top lever protrusion, such that the top lever handle is pivotally connected in a front end of the top lever handle to the outer body, in a front top pivotal point;
c) a bottom front lever, further including a bottom lever protrusion, such that the bottom front lever is pivotally connected to the outer body, in a bottom front pivotal point;
d) a top rear handle lever, wherein a front end of the top rear handle lever is pivotally connected to a rear end of the top front lever, in a rear top pivotal point;
e) a bottom rear handle lever, such that a front end of the bottom rear handle lever is pivotally connected to a rear end of the bottom front lever, in a rear bottom pivotal point, and a rear end of the top rear handle lever is pivotally connected to a rear end of the bottom rear handle lever, in a rear end pivotal point;
such that the top and bottom lever handles are mounted respectively above and under the top and bottom pieces, with the top and bottom lever protrusions positioned such that they are resting against respective outer surfaces of the top and bottom pieces, such that when an outside pressure is applied to respectively the top and bottom rear lever handles, thereby pressing the top and bottom rear lever handles together, such that top and bottom front levers are pressed together via the rear top and bottom pivotal points, such that a leveraged force is applied by the top and bottom lever protrusions to the outer surfaces of the top and bottom pieces, thereby pressing the top and bottom pieces together, and thereby causing the top and bottom blades to be pressed together.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A safety nail clipper for safe and fast cutting of a nail of a pet or wild animal, comprising:
a) a top piece;
b) a top blade, which is connected to a front end of the top piece;
c) a bottom piece, wherein the top piece is connected to the bottom piece;
d) a bottom blade, which is connected to a front end of the bottom piece; and
e) a funnel, which is positioned entirely in front of a cutting location, such that a rear aperture of the funnel is in front of the cutting location;
wherein the cutting location is formed when the top piece and the bottom piece are pressed together, such that the top blade and the bottom blade are in contact, along a line constituting the cutting location;
wherein the funnel is entirely in front of the cutting location, such that a rear aperture of the funnel is in front of the cutting location;
wherein a shape of the funnel is configured to guide the nail to the cutting location, such that when the top blade and the bottom blade are pressed together they meet at the cutting location, and thereby cut through the nail, between the tip of the nail, and the quick of the nail, leaving the quick of the nail untouched and safe, when the pet nail is led into and through the funnel.

2. The safety nail clipper of claim 1, further comprising:
a safety stop, which is positioned behind the cutting location;
whereby the funnel guides a pet nail into and through the funnel, such that the shape of the funnel guides the pet nail to the safety stop, that forms a wall preventing further entry, such that a tip of the pet nail comes to an automatic stop, simultaneously leaving a quick of the nail at a natural stop before reaching the cutting location; and
whereby further when the top blade and the bottom blade are pressed together the blades meet at the cutting location, and thereby cut through the pet nail between the tip of the pet nail and the quick of the nail, leaving the quick of the nail untouched and safe, such that the safety stop ensures that it is not possible to cut off more of the pet's nail than the equivalent of a distance between from where the top blade and the bottom blade come together, at the cutting location, to the safety stop.

3. The safety nail clipper of claim 1, wherein the top piece and the bottom piece are pivotally attached at a connection point, which forms a rotation center.

4. The safety nail clipper of claim 2, wherein a position of the safety stop is adjustable, whereby a distance between the safety stop and the cutting location is adjustable, thereby allowing for use with different sizes and types of pet nails.

5. The safety nail clipper of claim 4, further comprising:
a screw;
wherein the bottom piece further comprises a slit; and
wherein the screw protrudes through the slit and is screwed into the safety stop;
such that the safety stop is releasably secured in position by the screw, such that the screw and the safety stop are configured to slide along the slit, when the screw is untightened, such that the safety stop is secured in position when the screw is tightened.

6. The safety nail clipper of claim 1, wherein the funnel is configured with a narrowing shape, such that the front funnel aperture is wider than a rear funnel aperture.

7. The safety nail clipper of claim 1, wherein the funnel is a straight cylinder.

8. The safety nail clipper of claim 1, wherein the funnel is made of a transparent material.

9. The safety nail clipper of claim 2, further comprising an ejection hole located between the cutting location and the safety stop, whereby the ejection hole accommodates gravity induced falling out and emptying of nail cuttings.

10. The safety nail clipper of claim 1, wherein the top piece further comprises a top grip, and the bottom piece further comprises a bottom grip.

11. The safety nail clipper of claim 1, wherein the funnel further comprises at least one cutout.

12. The safety nail clipper of claim 1, wherein the funnel is comprised solely of a base, whereby the base functions as a resting platform.

13. The safety nail clipper of claim 2, wherein a front facing surface of the safety stop is rough, whereby it functions to smoothen the tip of the nail after cutting.

14. The safety nail clipper of claim 1, wherein the top and bottom blades are replaceable.

15. A safety nail clipper for safe and fast cutting of a nail of a pet or wild animal, comprising:
a) a nail clipper body;
b) a cutting implement, wherein the cutting implement is connected to the nail clipper body, and is configured to cut the nail at a pre-determined cutting location in the front of the nail clipper body, wherein further the nail is cut as a result of a cutting motion of the cutting implement; and
c) a funnel, which is positioned entirely in front of the cutting location, such that a rear aperture of the funnel is in front of the cutting location;
wherein a shape of the funnel is configured to guide the nail to the cutting location, such that during cutting motion of the cutting implement, the nail is cut between a tip of the nail and a quick of the nail, leaving the quick of the nail untouched and safe.

16. The safety nail clipper of claim 15, further comprising:
a safety stop, which is positioned behind the cutting location;
whereby the funnel is configured to guide the nail into and through the funnel, such that the shape of the funnel guides the nail to the safety stop, that forms a wall preventing further entry, such that a tip of the nail comes to an automatic stop, simultaneously leaving a quick of the nail at a natural stop before reaching the cutting location;
such that when the top blade and the bottom blade are pressed together the blades meet at the cutting location, and thereby cut through the pet nail between the tip of the pet nail and the quick of the nail, leaving the quick of the nail untouched and safe, such that the safety stop ensures that it is not possible to cut off more of the nail than the equivalent of a distance between from where the top blade and the bottom blade come together, at the cutting location, to the safety stop, which acts as a wall preventing further entry.

17. The safety nail clipper of claim 15, wherein the cutting implement further comprises a top piece connected with a top blade, and a bottom piece connected with a bottom blade, wherein the top piece and the bottom piece are pivotally attached at a connection point, which forms a rotation center.

18. The safety nail clipper of claim 17, wherein the top piece further comprises a top grip and the bottom piece further comprises a bottom grip.
